(19) United States
(12) Patent Application Publication
(10) Pub. No.: US 2025/0115831 A1
(43) Pub. Date: Apr. 10, 2025

(54) LIQUID HAND DISHWASHING DETERGENT COMPOSITION

(71) Applicant: The Procter & Gamble Company, Cincinnati, OH (US)

(72) Inventors: Denis Alfred GONZALES, Brussels (BE); Pieter Jan Maria SAVEYN, Destelbergen (BE); Evelyne Johanna Lutgarde VAN HECKE, Deinze (BE)

(21) Appl. No.: 18/906,232

(22) Filed: Oct. 4, 2024

(30) Foreign Application Priority Data
Oct. 4, 2023 (EP) 23201537.0

(51) Int. Cl. C11D 1/94; C11D 1/29; C11D 1/72; C11D 3/20

(52) U.S. Cl. CPC C11D 1/94; C11D 3/2044; C11D 1/29; C11D 1/72

(57) ABSTRACT

A liquid hand dishwashing detergent composition includes from about 5% to about 50% by weight of the composition of a surfactant system. The surfactant system includes anionic surfactant and amphoteric co-surfactant. The amphoteric co-surfactant is selected from amine oxide surfactant, wherein the amine oxide surfactant has the formula: R1N(R2)(R3)O. R1 is a C8-C18 alkyl, and the R2 and R3 moieties are selected from C1-C3 alkyl groups, C1-3 hydroxyalkyl groups, and mixtures thereof. The composition further includes from about 0.1% to about 10% of a mid-chain 1,2-alkanediol, and the mid-chain alkyl chain of the 1,2-alkanediol includes from 6 to 14 carbon atoms.

### TECHNICAL FIELD

The present disclosure relates to liquid hand dishwashing detergent compositions.

### BACKGROUND

Dishwashing detergents should provide superior cleaning performance and a robust foaming action. It has been observed that a reduced level of foaming creates a perception of inadequate cleaning, even when the detergent composition results in effective soil removal. This is primarily attributed to the common belief among users that an abundant and “rich” foam signifies a high degree of cleaning effectiveness.

Therefore, a need remains for a liquid detergent composition which provides for both effective cleaning, as well as enhanced foaming.

WO2022/199790A relates to a liquid detergent composition comprising or consisting of at least one hydroxyl compound selected from the group consisting of (a 1) 1,2-hexanediol; (a 2) 1,2-heptanediol; (a 3) 1,2-octanediol; (a 4) 1,2-decanediol; (a 5) 2,3-heptanediol (a 6) 2,3-hexanediol; (a 7) 2,3-octanediol; (a 8) 2,3-nonanediol; (a 9) glyceryl caprylate; (a 10) 4-hydroxyacetophenone; and optionally (b) tropolone or mixtures thereof. WO2023/122098A discloses cleaning compositions, e.g., dishwashing compositions, comprising one or more anionic surfactants comprising sodium laureth sulfate (SLES), one or more amphoteric surfactants, and an additive selected from caprylyl glycol, ethanol, and a combination thereof.

### SUMMARY

The present disclosure relates to a liquid hand dishwashing detergent composition comprising from 5% to 50% by weight of the composition of a surfactant system, wherein the surfactant system comprises anionic surfactant and amphoteric co-surfactant, wherein the amphoteric co-surfactant is selected from amine oxide surfactant; and wherein the composition further comprises from 0.1% to 10% of a mid-chain 1,2-alkanediol, wherein the mid-chain alkyl chain of the 1,2-alkanediol comprises from 6 to 14 carbon atoms.

The present disclosure further relates to a method of cleaning dishes comprising the steps of: delivering a composition of the present disclosure to a volume of water to form a wash solution; and immersing the dishware in the wash solution.

### DETAILED DESCRIPTION

Formulating liquid hand dishwashing detergent compositions to comprise mid-chain 1,2-alkanediols, as described herein, provides the composition with improved foaming. It has been found that formulating such compositions using amine oxide amphoteric co-surfactants has been found to further improve foaming, while additionally providing an improved soil removal.

As used herein, articles such as “a” and “an” when used in a claim, are understood to mean one or more of what is claimed or described.

The term “comprising” as used herein means that steps and ingredients other than those specifically mentioned can be added. This term encompasses the terms “consisting of” and “consisting essentially of.” The compositions of the present disclosure can comprise, consist of, and consist essentially of the essential elements and limitations of the examples described herein, as well as any of the additional or optional ingredients, components, steps, or limitations described herein.

The term “dishware” as used herein includes cookware and tableware made from, by non-limiting examples, ceramic, china, metal, glass, plastic (e.g., polyethylene, polypropylene, polystyrene, etc.) and wood.

The term “grease” or “greasy” as used herein means materials comprising at least in part (i.e., at least 0.5 wt % by weight of the grease in the material) saturated and unsaturated fats and oils, preferably oils and fats derived from animal sources such as beef, pig and/or chicken.

The terms “include”, “includes” and “including” are meant to be non-limiting.

The term “particulate soils” as used herein means inorganic and especially organic, solid soil particles, especially food particles, such as for non-limiting examples: finely divided elemental carbon, baked grease particle, and meat particles.

The term “sudsing profile” as used herein refers to the properties of the composition relating to suds character during the dishwashing process. The term “sudsing profile” of the composition includes initial suds volume generated upon dissolving and agitation, typically manual agitation, of the composition in the aqueous washing solution, and the retention of the suds during the dishwashing process. Preferably, hand dishwashing compositions characterized as having “good sudsing profile” tend to have high initial suds volume and/or sustained suds volume, particularly during a substantial portion of or for the entire manual dishwashing process. This is important as the consumer uses high suds as an indicator that enough composition has been dosed. Moreover, the consumer also uses the sustained suds volume as an indicator that enough active cleaning ingredients (e.g., surfactants) are present, even towards the end of the dishwashing process. The consumer usually renews the washing solution when the sudsing subsides. Thus, a low sudsing composition will tend to be replaced by the consumer more frequently than is necessary because of the low sudsing level.

“Easy rinsing” or “an easy rinsing profile” means that the foam generated during the main wash cycle can be rinsed faster and less water can be used to collapse the foam from the main wash cycle. Faster collapsing of the foam is preferred to reduce the amount of time spent rinsing and overall washing time, as well. Reducing the amount of water used to collapse the foam is preferred because it aids in water conservation.

It is understood that the test methods that are disclosed in the Test Methods Section of the present application must be used to determine the respective values of the parameters of Applicants' examples as described and claimed herein.

All percentages are by weight of the total composition, as evident by the context, unless specifically stated otherwise. All ratios are weight ratios, unless specifically stated otherwise, and all measurements are made at 25° C., unless otherwise designated.

### Liquid Hand Dishwashing Detergent Composition

The composition is a liquid composition, which is a liquid hand dishwashing composition, and hence is in liquid form. The liquid hand dishwashing composition is preferably an aqueous composition. As such, the composition can comprise from 50% to 85%, preferably from 50% to 75%, by weight of the total composition of water.

The composition may have a pH greater than or equal to 6.0, or a pH of from 6.0 to 12.0, preferably from 7.0 to 11.0, more preferably from 7.5 to 10.0, measured as a 10% aqueous solution in demineralized water at 20° C.

The composition of the present disclosure can be Newtonian or non-Newtonian, preferably Newtonian, over the usage shear rate range which is typically from 0.1 s⁻¹ to 100 s⁻¹. Preferably, when Newtonian, the composition has a viscosity of from 10 mPa·s to 10,000 mPa·s, preferably from 100 mPa·s to 5,000 mPa·s, more preferably from 300 mPa·s to 2,000 mPa·s, or most preferably from 500 mPa·s to 1,500 mPa·s, alternatively combinations thereof, over the typical usage shear rate range.

### Surfactant System

The liquid composition comprises from 5.0% to 50%, preferably from 6.0% to 40%, most preferably from 15% to 35%, by weight of the total composition of a surfactant system.

### Anionic Surfactant

The surfactant system comprises an anionic surfactant. The surfactant system can comprise at least 40%, preferably from 50% to 90%, more preferably from 65% to 85% by weight of the surfactant system of the anionic surfactant. The surfactant system is preferably free of fatty acid or salt thereof, since such fatty acids impede the generation of suds.

Suitable anionic surfactants can be selected from the group consisting of: alkyl sulfate surfactant, alkyl alkoxy sulfate surfactant, alkyl sulfonate surfactant, alkyl sulfosuccinate and dialkyl sulfosuccinate ester surfactants, and mixtures thereof.

The anionic surfactant can comprise at least 70%, preferably at least 85%, more preferably 100% by weight of the anionic surfactant of alkyl sulfate anionic surfactant, alkyl alkoxy sulfate anionic surfactant, or a mixture thereof.

The mol average alkyl chain length of the alkyl sulfate anionic surfactant or the alkyl alkoxy sulfate anionic surfactant can be from 8 to 18, preferably from 10 to 14, more preferably from 12 to 14, most preferably from 12 to 13 carbon atoms, in order to provide a combination of improved grease removal and enhanced speed of cleaning.

The alkyl chain of the alkyl sulfate anionic surfactant or the alkyl alkoxy sulfate anionic surfactant can have a mol fraction of C12 and C13 chains of at least 50%, preferably at least 65%, more preferably at least 80%, most preferably at least 90%. Suds mileage is particularly improved, especially in the presence of greasy soils, when the C13/C12 mol ratio of the alkyl chain is at least 57/43, preferably from 60/40 to 90/10, more preferably from 60/40 to 80/20, most preferably from 60/40 to 70/30, while not compromising suds mileage in the presence of particulate soils.

The relative molar amounts of C13 and C12 alkyl chains in the alkyl sulfate anionic surfactant or the alkyl alkoxy sulfate anionic surfactant can be derived from the carbon chain length distribution of the surfactants. The carbon chain length distributions of the alkyl chains of the alkyl sulfate and alkyl alkoxy sulfate surfactants can be obtained from the technical data sheets from the suppliers for the surfactant or constituent alkyl alcohol. Alternatively, the chain length distribution and average molecular weight of the fatty alcohols, used to make the alkyl sulfate anionic surfactant or the alkyl alkoxy sulfate anionic surfactant, can also be determined by methods known in the art. Such methods include capillary gas chromatography with flame ionization detection on medium polar capillary column, using hexane as the solvent. The chain length distribution is based on the starting alcohol and alkoxylated alcohol. As such, the alkyl sulfate anionic surfactant should be hydrolyzed back to the corresponding alkyl alcohol and alkyl alkoxylated alcohol before analysis, for instance using hydrochloric acid.

The alkyl alkoxy sulfate surfactant can have an average degree of alkoxylation of less than 3.5, preferably from 0.3 to 2.0, more preferably from 0.5 to 0.9, in order to improve low temperature physical stability and improve suds mileage of the compositions of the present disclosure. When alkoxylated, ethoxylation is preferred.

The average degree of alkoxylation is the mol average degree of alkoxylation (i.e., mol average alkoxylation degree) of all the alkyl sulfate anionic surfactant. Hence, when calculating the mol average alkoxylation degree, the mols of non-alkoxylated sulfate anionic surfactant are included:

$$Mol average alkoxylation degree = ( x 1 * alkoxylation degree of surfactant 1 + x 2 * alkoxylation degree of surfactant 2 + … ) / ( x 1 + x 2 + … )$$

where x1, x2, . . . are the number of moles of each alkyl (or alkoxy) sulfate anionic surfactant of the mixture and alkoxylation degree is the number of alkoxy groups in each alkyl sulfate anionic surfactant.

Preferred alkyl alkoxy sulfates are alkyl ethoxy sulfates.

The alkyl sulfate anionic surfactant and the alkyl alkoxy sulfate anionic surfactant can have a weight average degree of branching of at least 10%, preferably from 20% to 60%, more preferably from 30% to 50%. Alternatively, the alkyl sulfate anionic surfactant and the alkyl alkoxy sulfate anionic surfactant can have a weight average degree of branching of less than 10%, preferably the alkyl sulfate anionic surfactant and the alkyl alkoxy sulfate anionic surfactant are free of branching.

The alkyl sulfate anionic surfactant and the alkyl alkoxy sulfate anionic surfactant can comprise at least 5%, preferably at least 10%, most preferably at least 25%, by weight of the surfactant, of branching on the C2 position (as measured counting carbon atoms from the sulfate group for non-alkoxylated alkyl sulfate anionic surfactants and counting from the alkoxy-group furthest from the sulfate group for alkoxylated alkyl sulfate anionic surfactants). More preferably, greater than 75%, even more preferably greater than 90%, by weight of the total branched alkyl content consists of C1-C5 alkyl moiety, preferably C1-C2 alkyl moiety. It has been found that formulating the inventive compositions using alkyl sulfate surfactants or alkyl alkoxy sulfate surfactants having the aforementioned degree of branching results in improved low temperature stability. Such compositions require less solvent in order to achieve good physical stability at low temperatures. As such, the compositions can comprise lower levels of organic solvent, such as less than 5.0% by weight of the liquid composition of organic solvent, while still having improved low temperature stability. Higher surfactant branching also provides faster initial suds generation, but typically less suds mileage. The weight average branching, described herein, has been found to provide improved low temperature stability, initial foam generation and suds longevity.

The weight average degree of branching for an anionic surfactant mixture can be calculated using the following formula:

$$Weight average of branching ( \% ) = [ ( x 1 * wt \% branched alcohol 1 in alcohol 1 + x 2 * wt \% branched alcohol 2 in alcohol 2 + … ) / ( x 1 + x 2 + … ) ] * 100$$

where x1, x2, . . . are the weight in grams of each alcohol in the total alcohol mixture of the alcohols which were used as starting material before (alkoxylation and) sulfation to produce the alkyl (alkoxy) sulfate anionic surfactant. In the weight average degree of branching calculation, the weight of the alkyl alcohol used to form the alkyl sulfate anionic surfactant which is not branched is included.

The weight average degree of branching and the distribution of branching can typically be obtained from the technical data sheet for the surfactant or constituent alkyl alcohol. Alternatively, the branching can also be determined through analytical methods known in the art, including capillary gas chromatography with flame ionization detection on medium polar capillary column, using hexane as the solvent. The weight average degree of branching and the distribution of branching is based on the starting alcohol used to produce the alkyl sulfate anionic surfactant.

Suitable counterions include alkali metal cation earth alkali metal cation, alkanolammonium or ammonium or substituted ammonium, but preferably sodium.

Suitable examples of commercially available alkyl sulfate anionic surfactants include, those derived from alcohols sold under the Neodol® brand-name by Shell, or the Lial®, Isalchem®, and Safol® brand-names by Sasol, or some of the natural alcohols produced by The Procter & Gamble Chemicals company. The alcohols can be blended in order to achieve the desired mol fraction of C12 and C13 chains and the desired C13/C12 ratio, based on the relative fractions of C13 and C12 within the starting alcohols, as obtained from the technical data sheets from the suppliers or from analysis using methods known in the art.

The performance can be affected by the width of the alkoxylation distribution of the alkoxylated alkyl sulfate anionic surfactant, including grease cleaning, sudsing, low temperature stability and viscosity of the finished product. The alkoxylation distribution, including its broadness can be varied through the selection of catalyst and process conditions when making the alkoxylated alkyl sulfate anionic surfactant.

If ethoxylated alkyl sulfate is present, without wishing to be bound by theory, through tight control of processing conditions and feedstock material compositions, both during alkoxylation especially ethoxylation and sulfation steps, the amount of 1,4-dioxane by-product within alkoxylated especially ethoxylated alkyl sulfates can be reduced. Based on recent advances in technology, a further reduction of 1,4-dioxane by-product can be achieved by subsequent stripping, distillation, evaporation, centrifugation, microwave irradiation, molecular sieving or catalytic or enzymatic degradation steps. Processes to control 1,4-dioxane content within alkoxylated/ethoxylated alkyl sulfates have been described extensively in the art. Alternatively 1,4-dioxane level control within detergent formulations has also been described in the art through addition of 1,4-dioxane inhibitors to 1,4-dioxane comprising formulations, such as 5,6-dihydro-3-(4-morpholinyl)-1-[4-(2-oxo-1-piperidinyl)-phenyl]-2-(1-H)-pyridone, 3-α-hydroxy-7-oxo stereoisomer-mixtures of cholinic acid, 3-(N-methyl amino)-L-alanine, and mixtures thereof.

Anionic alkyl sulfonate or sulfonic acid surfactants suitable for use herein include the acid and salt forms of alkylbenzene sulfonates, alkyl ester sulfonates, primary and secondary alkane sulfonates such as paraffin sulfonates, alfa or internal olefin sulfonates, alkyl sulfonated (poly)carboxylic acids, and mixtures thereof. Suitable anionic sulfonate or sulfonic acid surfactants include: C5-C20 alkylbenzene sulfonates, more preferably C10-C16 alkylbenzene sulfonates, more preferably C11-C13 alkylbenzene sulfonates, C5-C20 alkyl ester sulfonates especially C5-C20 methyl ester sulfonates, C6-C22 primary or secondary alkane sulfonates, C5-C20 sulfonated (poly)carboxylic acids, and any mixtures thereof, but preferably C11-C13 alkylbenzene sulfonates. The aforementioned surfactants can vary widely in their 2-phenyl isomer content. Compared with sulfonation of alpha olefins, the sulfonation of internal olefins can occur at any position since the double bond is randomly positioned, which leads to the position of hydrophilic sulfonate and hydroxyl groups of IOS in the middle of the alkyl chain, resulting in a variety of twin-tailed branching structures. Alkane sulfonates include paraffin sulfonates and other secondary alkane sulfonate (such as Hostapur SAS60 from Clariant).

Alkyl sulfosuccinate and dialkyl sulfosuccinate esters are organic compounds with the formula MO3SCH(CO2R′)CH2CO2R where R and R′ can be H or alkyl groups, and M is a counter-ion such as sodium (Na). Alkyl sulfosuccinate and dialkyl sulfosuccinate ester surfactants can be alkoxylated or non-alkoxylated, preferably non-alkoxylated. The surfactant system may comprise further anionic surfactant. However, the composition preferably comprises less than 30%, preferably less than 15%, more preferably less than 10% by weight of the surfactant system of further anionic surfactant. Most preferably, the surfactant system comprises no further anionic surfactant, preferably no other anionic surfactant than alkyl sulfate anionic surfactant.

### Co-Surfactant

In order to improve foaming, as well as surfactant packing after dilution and hence improve suds mileage, the surfactant system can comprise a co-surfactant. The co-surfactant comprises an amphoteric surfactant which is an amine oxide surfactant, wherein the amine oxide surfactant has the formula: R1N(R2)(R3)O, wherein R1 is a C8-C18 alkyl, and the R2 and R3 moieties are selected from the group consisting of C1-C3 alkyl groups, C1-C3 hydroxyalkyl groups, and mixtures thereof.

The anionic surfactant to the amine oxide amphoteric co-surfactant weight ratio can be from 1:1 to 8:1, preferably from 2:1 to 5:1, more preferably from 2.5:1 to 4:1.

The composition preferably comprises from 0.1% to 20%, more preferably from 0.5% to 15% and especially from 2% to 10% by weight of the composition of the amine oxide amphoteric co-surfactant.

The surfactant system of the composition of the present disclosure preferably comprises up to 50%, preferably from 10% to 40%, more preferably from 15% to 35%, by weight of the surfactant system of the amine oxide amphoteric co-surfactant.

The amine oxide amphoteric surfactant can be linear or branched, though linear are preferred. Suitable linear amine oxides are typically water-soluble.

R2 and R3 can be selected from the group consisting of methyl, ethyl, propyl, isopropyl, 2-hydroxethyl, 2-hydroxypropyl and 3-hydroxypropyl, and mixtures thereof, though methyl is preferred for one or both of R2 and R3, preferably both. The linear amine oxide surfactants, in particular, may include linear C10-C18 alkyl dimethyl amine oxides and linear C8-C12 alkoxy ethyl dihydroxy ethyl amine oxides.

Preferably, the amine oxide surfactant is selected from the group consisting of alkyl dimethyl amine oxide and mixtures thereof. Alkyl dimethyl amine oxides are particularly preferred, such as C8-18 alkyl dimethyl amine oxides, or C10-16 alkyl dimethyl amine oxides (such as coco dimethyl amine oxide). Suitable alkyl dimethyl amine oxides include C10 alkyl dimethyl amine oxide surfactant, C10-12 alkyl dimethyl amine oxide surfactant, C12-C14 alkyl dimethyl amine oxide surfactant, or mixtures thereof. C12-C14 alkyl dimethyl amine oxide is particularly preferred, especially linear C12-14 alkyl dimethyl amine oxide. Suitable linear C12-C14 alkyl dimethyl amine oxide surfactants can be derived from natural alcohols, especially coconut oil derived alcohols, or can be derived from synthetic alcohols through the Ziegler process.

Alternative suitable amine oxide surfactants include mid-branched amine oxide surfactants. As used herein, “mid-branched” means that the amine oxide has one alkyl moiety having n1 carbon atoms with one alkyl branch on the alkyl moiety having n2 carbon atoms. The alkyl branch is located on the α carbon from the nitrogen on the alkyl moiety. This type of branching for the amine oxide is also known in the art as an internal amine oxide. The total sum of n1 and n2 can be from 10 to 24 carbon atoms, preferably from 12 to 20, and more preferably from 10 to 16. The number of carbon atoms for the one alkyl moiety (n1) is preferably the same or similar to the number of carbon atoms as the one alkyl branch (n2) such that the one alkyl moiety and the one alkyl branch are symmetric. As used herein, “symmetric” means that |n1-n2| is less than or equal to 5, preferably 4, most preferably from 0 to 4 carbon atoms in at least 50 wt %, more preferably at least 75 wt % to 100 wt % of the mid-branched amine oxides for use herein. The amine oxide further comprises two moieties, independently selected from a C1-C3 alkyl, a C1-C3 hydroxyalkyl group, or a polyethylene oxide group containing an average of from about 1 to about 3 ethylene oxide groups. Preferably, the two moieties are selected from a C1-C3 alkyl, more preferably both are selected as C1 alkyl.

Alternatively, the amine oxide surfactant can be a mixture of amine oxides comprising a mixture of low-cut amine oxide and mid-cut amine oxide. The amine oxide of the composition of the present disclosure can then comprises:
a) from about 10% to about 45% by weight of the amine oxide of low-cut amine oxide of formula R1R2R3AO wherein R1 and R2 are independently selected from hydrogen, C1-C4 alkyls or mixtures thereof, and R3 is selected from C10 alkyls and mixtures thereof; and
b) from 55% to 90% by weight of the amine oxide of mid-cut amine oxide of formula R4R5R6AO wherein R4 and R5 are independently selected from hydrogen, C1-C4 alkyls or mixtures thereof, and R6 is selected from C12-C16 alkyls or mixtures thereof

In a preferred low-cut amine oxide for use herein R3 is n-decyl, with preferably both R1 and R2 being methyl. In the mid-cut amine oxide of formula R4R5R6AO, R4 and R5 are preferably both methyl.

Preferably, the amine oxide comprises less than about 5%, more preferably less than 3%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Limiting the amount of amine oxides of formula R7R8R9AO improves both physical stability and suds mileage.

The composition can comprise further co-surfactant selected from zwitterionic surfactants including betaine surfactants. However, preferably, the composition comprises less than 5.0%, preferably less than 1.0%, more preferably less than 0.5% by weight of the composition of such betaine surfactants, and is most preferably free of betaine surfactant.

If present, suitable betaine surfactants include alkyl betaines, alkylamidobetaine, amidazoliniumbetaine, sulfobetaine (INCI Sultaines) as well as the phosphobetaine, and preferably meets formula (I):

R1-[CO—X(CH2)ₙ]ₓ-N⁺(R2)(R3)-(CH₂)ₘ—[CH(OH)—CH₂]_{y}—Y—
Wherein in formula (I),
R1 is selected from the group consisting of: a saturated or unsaturated C6-22 alkyl residue, preferably C8-18 alkyl residue, more preferably a saturated C10-16 alkyl residue, most preferably a saturated C12-C14 alkyl residue;
X is selected from the group consisting of: NH, NR4 wherein R4 is a C1-4 alkyl residue, O, and S,
n is an integer from 1 to 10, preferably 2 to 5, more preferably 3,
x is 0 or 1, preferably 1,
R2 and R3 are independently selected from the group consisting of: a C1-4 alkyl residue, hydroxy substituted such as a hydroxyethyl, and mixtures thereof, preferably both R2 and R3 are methyl,
m is an integer from 1 to 4, preferably 1, 2 or 3,
y is 0 or 1, and
Y is selected from the group consisting of: COO, SO₃, OPO(OR5)O or P(O)(OR5)O, wherein R5 is H or a C1-4 alkyl residue.

Preferred betaines are the alkyl betaines of formula (Ia), the alkyl amido propyl betaine of formula (Ib), the sulfobetaine of formula (Ic) and the amido sulfobetaine of formula (Id):

R1-N⁺(CH₃)₂—CH₂COO— (Ia)

R1-CO—NH—(CH₂)₃—N⁺(CH₃)₂—CH₂COO— (Ib)

R1-N⁺(CH₃)₂—CH₂CH(OH)CH₂SO₃⁻ (Ic)

R1-CO—NH—(CH₂)₃—N⁺(CH₃)₂—CH₂CH(OH)CH₂SO₃⁻ (Id)
in which R1 has the same meaning as in formula (I). Particularly preferred are the carbobetaines [i.e., where Y═COO in formula (I)] of formulae (Ia) and (Ib), more preferred are the alkylamidobetaine of formula (Ib).

Suitable betaines can be selected from the group consisting or [designated in accordance with INCI]: capryl/capramidopropyl betaine, cetyl betaine, cetyl amidopropyl betaine, cocamidoethyl betaine, cocamidopropyl betaine, cocobetaines, decyl betaine, decyl amidopropyl betaine, hydrogenated tallow betaine/amidopropyl betaine, isostearamidopropyl betaine, lauramidopropyl betaine, lauryl betaine, myristyl amidopropyl betaine, myristyl betaine, oleamidopropyl betaine, oleyl betaine, palmamidopropyl betaine, palmitamidopropyl betaine, palm-kernelamidopropyl betaine, stearamidopropyl betaine, stearyl betaine, tallowamidopropyl betaine, tallow betaine, undecylenamidopropyl betaine, undecyl betaine, and mixtures thereof. Preferred betaines are selected from the group consisting of: cocamidopropyl betaine, cocobetaines, lauramidopropyl betaine, lauryl betaine, myristyl amidopropyl betaine, myristyl betaine, and mixtures thereof. Cocamidopropyl betaine is particularly preferred.

### Nonionic Surfactant

The surfactant system can further comprise a nonionic surfactant. Suitable nonionic surfactants include alkoxylated alcohol nonionic surfactants, alkyl polyglucoside nonionic surfactants, and mixtures thereof, preferably alkoxylated alcohol nonionic surfactants.

### Alkoxylated Alcohol Nonionic Surfactant:

If present, the surfactant system of the composition of the present disclosure can comprise from 0.1% to 10%, preferably from 2.0% to 9.0%, more preferably from 4.0% to 8.0% by weight of the detergent composition, of an alkoxylated alcohol non-ionic surfactant.

Preferably, the alkoxylated alcohol non-ionic surfactant is a linear or branched, primary or secondary alkyl alkoxylated non-ionic surfactant, preferably an alkyl ethoxylated non-ionic surfactant, preferably comprising on average from 9 to 15, preferably from 10 to 14 carbon atoms in its alkyl chain and on average from 5 to 12, preferably from 6 to 10, most preferably from 7 to 8, units of ethylene oxide per mole of alcohol.

### Alkyl Polyglucoside Monionic Surfactant:

If present, the alkyl polyglucoside can be present in the surfactant system at a level of from 0.1% to 10%, preferably from 2.0% to 9.0%, more preferably from 4.0% to 8.0% by weight of the detergent composition. Alkyl polyglucoside nonionic surfactants are typically more sudsing than other nonionic surfactants such as alkyl ethoxlated alcohols.

A combination of alkylpolyglucoside and anionic surfactant especially alkyl sulfate anionic surfactant, has been found to improve polymerized grease removal, suds mileage performance, reduced viscosity variation with changes in the surfactant and/or system, and a more sustained Newtonian rheology.

The alkyl polyglucoside surfactant can be selected from C6-C18 alkyl polyglucoside surfactant. The alkyl polyglucoside surfactant can have a number average degree of polymerization of from 0.1 to 3.0, preferably from 1.0 to 2.0, more preferably from 1.2 to 1.6. The alkyl polyglucoside surfactant can comprise a blend of short chain alkyl polyglucoside surfactant having an alkyl chain comprising 10 carbon atoms or less, and mid to long chain alkyl polyglucoside surfactant having an alkyl chain comprising greater than 10 carbon atoms to 18 carbon atoms, preferably from 12 to 14 carbon atoms.

Short chain alkyl polyglucoside surfactants have a monomodal chain length distribution between C8-C10, mid to long chain alkyl polyglucoside surfactants have a monomodal chain length distribution between C10-C18, while mid chain alkyl polyglucoside surfactants have a monomodal chain length distribution between C12-C14. In contrast, C8 to C18 alkyl polyglucoside surfactants typically have a monomodal distribution of alkyl chains between C8 and C18, as with C8 to C16 and the like. As such, a combination of short chain alkyl polyglucoside surfactants with mid to long chain or mid chain alkyl polyglucoside surfactants have a broader distribution of chain lengths, or even a bimodal distribution, than non-blended C8 to C18 alkyl polyglucoside surfactants. Preferably, the weight ratio of short chain alkyl polyglucoside surfactant to long chain alkyl polyglucoside surfactant is from 1:1 to 10:1, preferably from 1.5:1 to 5:1, more preferably from 2:1 to 4:1. It has been found that a blend of such short chain alkyl polyglucoside surfactant and long chain alkyl polyglucoside surfactant results in faster dissolution of the detergent solution in water and improved initial sudsing, in combination with improved suds stability.

C8-C16 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation). Glucopon® 215UP is a preferred short chain APG surfactant. Glucopon® 600CSUP is a preferred mid to long chain APG surfactant.

In preferred compositions, the surfactant system can comprise an alkyl sulfate anionic surfactant having an average degree of branching of less than 10% and alkyl polyglucoside nonionic surfactant.

### 1,2-alkanediol

The liquid hand dishwashing detergent composition comprises from 0.1% to 10%, preferably from 0.25% to 5%, more preferably from 0.5% to 2% by weight of the liquid hand dishwashing detergent composition of mid-chain C1,2-alkanediol. Mid-chain 1,2-alkanediols of use in the present disclosure comprise from 6 to 14, more preferably from 8 to 12, most preferably from 8 to 10 carbon atoms.

The alkyl chain of the mid-chain 1,2-alkanediol is preferably a linear alkyl chain. Preferably the 1,2-alkanediol comprises an even number of carbon atoms, and more preferably the alkyl chain is derived from natural sources, such as fatty acids. Suitable C6 to C14 1,2-alkanediols include straight alkyl chain 1,2-hexanediol, 1,2-octanediol, 1,2-decanediol, 1,2-dodecanediol, 1,2-tetradecanediol, or mixtures thereof, preferably 1,2-octanediol, 1,2-decanediol, 1,2-dodecanediol, and mixtures thereof, most preferably 1,2-octanediol, 1,2-decanediol, and mixtures thereof.

The mid-chain 1,2-alkanediols of use in the compositions of the present disclosure have been found to improve foamability and cleaning of the detergent composition while building viscosity of the liquid detergent composition.

In contrast, 1,2-alkanediols comprising less than 6 carbon atoms have been found to reduce the viscosity of liquid hand dishwashing compositions. Long-chain 1,2-alkanediols comprising more than 14 carbon atoms have been found to be challenging to dissolve while impairing the physically stability of the resultant liquid detergent composition. It is believed that mid-chain 1,2-alkanediols provide a hydrophilic-lipophilic balance which results in good interaction with the hydrophobic tails of the surfactant contained within the liquid detergent composition, while still being soluble in the aqueous detergent composition.

At least 50%, preferably at least 80%, more preferably at least 98% by weight of the 1,2-alkanediols present in the composition can be mid-chain 1,2-alkanediols. Even more preferably, the liquid composition is free of any 1,2-alkanediol comprising alkyl chains having less than 6 or more than 14 carbon atoms.

The liquid hand dishwashing composition can comprise the mid-chain 1,2-alkanediol and the surfactant system in a weight ratio of from 1:60 to 1:1, preferably from 1:40 to 1:5, more preferably 1:30 to 1:10.

Suitable mid-chain 1,2-alkanediols include the R-isomer, S-isomer, or a mixture thereof.

Suitable 1,2-alkanediols products are available from the Symrise or the Sigma Aldrich companies.

### Divalent Salts

The composition preferably comprises a divalent metal salt, preferably a salt of Calcium or Magnesium (Ca²⁺ or Mg²⁺ salt). Suitable divalent salts include magnesium and/or calcium salts of: chlorides, sulfates, carbonates, bicarbonates, linear alkyl benzene sulfonic acid, and mixtures thereof, with magnesium salts being particularly preferred. Magnesium salts of chlorides, sulfates, linear alkyl benzene sulfonic acid, and mixtures thereof are particularly preferred, more particularly magnesium salts of chlorides, sulfates, and mixtures thereof, with magnesium chloride being most preferred.

If calcium salts are present, the magnesium ions and calcium ions are preferably present in a molar ratio of 1:1 or greater, preferably 1.5:1 or greater, preferably 2:1 or greater.

Compositions of the present disclosure, which further comprise such divalent salts have been found to improve cleaning as well as reduce the slipperiness of the dishware after they have been cleaned with such compositions. It is believed that some residual anionic surfactant remains on the dishware, and the presence of the divalent ions reduces the electrostatic interaction between the residual anionic surfactant, both improving cleaning and reducing slipperiness, especially when the dishware is washed using soft water having a hardness of less than 1.25 mmol/l calcium equivalence.

The divalent salts are preferably water-soluble. As used herein, the term “water-soluble” refers to a compound that can be dissolved in water at a concentration of more than 1.0% by weight in distilled water at 21° C.

### Further Ingredients

The composition can comprise further ingredients such as those selected from: amphiphilic alkoxylated polyalkyleneimines, triblock copolymers, hydrotropes, organic solvents, other adjunct ingredients such as those described herein, and mixtures thereof.

### Amphiphilic Alkoxylated Polyalkyleneimine:

The composition of the present disclosure may further comprise from 0.05% to 2%, preferably from 0.07% to 1% by weight of the total composition of an amphiphilic polymer. Suitable amphiphilic polymers can be selected from the group consisting of: amphiphilic alkoxylated polyalkyleneimine, and mixtures thereof. The amphiphilic alkoxylated polyalkyleneimine polymer has been found to reduce gel formation on the hard surfaces to be cleaned when the liquid composition is added directly to a cleaning implement (such as a sponge) before cleaning and consequently brought in contact with heavily greased surfaces, especially when the cleaning implement comprises a low amount to nil water such as when light pre-wetted sponges are used.

A preferred amphiphilic alkoxylated polyethyleneimine polymer has the general structure of formula (I):

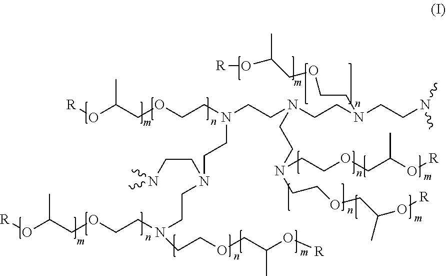

where the polyethyleneimine backbone has a weight average molecular weight of 600, n of formula (I) has an average of 10, m of formula (I) has an average of 7 and R of formula (I) is selected from hydrogen, a C₁-C₄ alkyl and mixtures thereof, preferably hydrogen. The degree of permanent quaternization of formula (I) may be from 0% to 22% of the polyethyleneimine backbone nitrogen atoms. The molecular weight of this amphiphilic alkoxylated polyethyleneimine polymer preferably is between 10,000 and 15,000 Da.

More preferably, the amphiphilic alkoxylated polyethyleneimine polymer has the general structure of formula (I) but wherein the polyethyleneimine backbone has a weight average molecular weight of 600 Da, n of Formula (I) has an average of 24, m of Formula (I) has an average of 16 and R of Formula (I) is selected from hydrogen, a C₁-C₄ alkyl and mixtures thereof, preferably hydrogen. The degree of permanent quaternization of Formula (I) may be from 0% to 22% of the polyethyleneimine backbone nitrogen atoms and is preferably 0%. The molecular weight of this amphiphilic alkoxylated polyethyleneimine polymer preferably is between 25,000 and 30,000, most preferably 28,000 Da.

The amphiphilic alkoxylated polyethyleneimine polymers can be made by the methods described in more detail in PCT Publication No. WO 2007/135645.

Alternatively, the compositions can be free of amphiphilic polymers.

### Triblock Copolymer:

The composition of the present disclosure can comprise a triblock copolymer. The triblock co-polymers can be present at a level of from 1% to 20%, preferably from 3% to 15%, more preferably from 5% to 12%, by weight of the total composition. Suitable triblock copolymers include alkylene oxide triblock co-polymers, defined as a triblock co-polymer having alkylene oxide moieties according to Formula (I): (EO)ₓ(PO)_{y}(EO)ₓ, wherein EO represents ethylene oxide, and each x represents the number of EO units within the EO block. Each x can independently be on average of from 5 to 50, preferably from 10 to 40, more preferably from 10 to 30. Preferably x is the same for both EO blocks, wherein the “same” means that the x between the two EO blocks varies within a maximum 2 units, preferably within a maximum of 1 unit, more preferably both x's are the same number of units. PO represents propylene oxide, and y represents the number of PO units in the PO block. Each y can on average be from between 28 to 60, preferably from 30 to 55, more preferably from 30 to 48.

Preferably the triblock co-polymer has a ratio of y to each x of from 3:1 to 2:1. The triblock co-polymer preferably has a ratio of y to the average x of 2 EO blocks of from 3:1 to 2:1. Preferably the triblock co-polymer has an average weight percentage of total E-O of between 30% and 50% by weight of the tri-block co-polymer. Preferably the triblock co-polymer has an average weight percentage of total PO of between 50% and 70% by weight of the triblock co-polymer. It is understood that the average total weight % of EO and PO for the triblock co-polymer adds up to 100%. The triblock co-polymer can have an average molecular weight of between 2060 and 7880, preferably between 2620 and 6710, more preferably between 2620 and 5430, most preferably between 2800 and 4700. Average molecular weight is determined using a 1H NMR spectroscopy (see Thermo scientific application note No. AN52907).

Triblock co-polymers have the basic structure ABA, wherein A and B are different homopolymeric and/or monomeric units. In this case A is ethylene oxide (EO) and B is propylene oxide (PO). Those skilled in the art will recognize the phrase “block copolymers” is synonymous with this definition of “block polymers”.

Triblock co-polymers according to Formula (I) with the specific EO/PO/EO arrangement and respective homopolymeric lengths have been found to enhances suds mileage performance of the liquid hand dishwashing detergent composition in the presence of greasy soils and/or suds consistency throughout dilution in the wash process.

Suitable EO-PO-EO triblock co-polymers are commercially available from BASF such as Pluronic® PE series, and from the Dow Chemical Company such as Tergitol™ L series. Particularly preferred triblock co-polymer from BASF are sold under the tradenames Pluronic® PE6400 (MW ca 2900, ca 40 wt % EO) and Pluronic® PE 9400 (MW ca 4600, 40 wt % EO). Particularly preferred triblock co-polymer from the Dow Chemical Company is sold under the tradename Tergitol™ L64 (MW ca 2700, ca 40 wt % EO).

Preferred triblock co-polymers are readily biodegradable under aerobic conditions.

### Cyclic Polyamine:

The composition can comprise a cyclic polyamine having amine functionalities that helps cleaning. The composition of the present disclosure preferably comprises from 0.1% to 3%, more preferably from 0.2% to 2%, and especially from 0.5% to 1%, by weight of the composition, of the cyclic polyamine.

The cyclic polyamine has at least two primary amine functionalities. The primary amines can be in any position in the cyclic amine but it has been found that in terms of grease cleaning, better performance is obtained when the primary amines are in positions 1,3. It has also been found that cyclic amines in which one of the substituents is —CH3 and the rest are H provided for improved grease cleaning performance.

Accordingly, the most preferred cyclic polyamine for use with the cleaning composition of the present disclosure are cyclic polyamine selected from the group consisting of: 2-methylcyclohexane-1,3-diamine, 4-methylcyclohexane-1,3-diamine and mixtures thereof. These specific cyclic polyamines work to improve suds and grease cleaning profile through-out the dishwashing process when formulated together with the surfactant system of the composition of the present disclosure.

Suitable cyclic polyamines can be supplied by BASF, under the Baxxodur tradename, with Baxxodur ECX-210 being particularly preferred.

A combination of the cyclic polyamine and magnesium sulfate is particularly preferred. As such, the composition can further comprise magnesium sulfate at a level of from 0.001% to 2.0%, preferably from 0.005% to 1.0%, more preferably from 0.01% to 0.5% by weight of the composition.

### Salt, Hydrotrope, Organic Solvent:

The composition of the present disclosure may further comprise at least one active selected from the group consisting of: i) a salt, ii) a hydrotrope, iii) an organic solvent, and mixtures thereof.

The composition of the present disclosure may comprise from about 0.05% to about 2%, preferably from about 0.1% to about 1.5%, or more preferably from about 0.5% to about 1%, by weight of the total composition of a salt, preferably a monovalent or divalent inorganic salt, or a mixture thereof, more preferably selected from: sodium chloride, sodium sulfate, and mixtures thereof. Sodium chloride is most preferred.

The composition of the present disclosure may comprise from about 0.1% to about 10%, or preferably from about 0.5% to about 10%, or more preferably from about 1% to about 10% by weight of the total composition of a hydrotrope or a mixture thereof, preferably sodium cumene sulfonate.

The composition can comprise from about 0.1% to about 10%, or preferably from about 0.5% to about 10%, or more preferably from about 1% to about 10% by weight of the total composition of an organic solvent. Suitable organic solvents include organic solvents selected from the group consisting of: alcohols, glycols, glycol ethers, and mixtures thereof, preferably alcohols, glycols, and mixtures thereof. Ethanol is the preferred alcohol. Polyalkyleneglycols, especially polypropyleneglycol, is the preferred glycol, with polypropyleneglycols having a weight average molecular weight of from 750 Da to 1,400 Da being particularly preferred.

### Adjunct Ingredients

The composition may optionally comprise a number of other adjunct ingredients such as builders (preferably citrate), chelants, conditioning polymers, other cleaning polymers, surface modifying polymers, structurants, emollients, humectants, skin rejuvenating actives, enzymes, carboxylic acids, scrubbing particles, perfumes, malodor control agents, pigments, dyes, opacifiers, pearlescent particles, inorganic cations such as alkaline earth metals such as Ca/Mg-ions, antibacterial agents, preservatives, viscosity adjusters (e.g., salt such as NaCl, and other mono-, di- and trivalent salts) and pH adjusters and buffering means (e.g. carboxylic acids such as citric acid, HCl, NaOH, KOH, alkanolamines, carbonates such as sodium carbonates, bicarbonates, sesquicarbonates, and alike).

### Packaged Product

The hand dishwashing detergent composition can be packaged in a container, typically plastic containers. Suitable containers comprise an orifice. Suitable containers include traditional upright dosing containers, where the orifice is at the top of the container, and inverted/bottom dosing containers, where the orifice is at the bottom of the container. For inverted/bottom dosing containers, the orifice may be capped and/or the orifice may comprise a slit valve, such as described in U.S. Pat. No. 10,611,531. Typically, the container comprises a cap, with the orifice typically comprised on the cap. The cap can comprise a spout, with the orifice at the exit of the spout. The spout can have a length of from 0.5 mm to 10 mm.

The orifice can have an open cross-sectional surface area at the exit of from 3 mm2 to 20 mm2, preferably from 3.8 mm2 to 12 mm2, more preferably from 5 mm2 to 10 mm2, wherein the container further comprises the composition according to the present disclosure. The cross-sectional surface area is measured perpendicular to the liquid exit from the container (that is, perpendicular to the liquid flow during dispensing).

The container can typically comprise from 200 ml to 5,000 ml, preferably from 350 ml to 2000 ml, more preferably from 400 ml to 1,000 ml of the liquid hand dishwashing detergent composition.

### Method of Washing

The present disclosure is further directed to a method of manually washing dishware with the composition of the present disclosure. The method comprises the step of contacting the dishware with a composition according to the present disclosure.

Suitable methods can include the step of delivering a composition of the present disclosure to a volume of water to form a wash solution and immersing the dishware in the solution, in order to contact the dishware with the composition of the present disclosure. The dishware is then cleaned with the composition in the presence of water.

The dishware can be rinsed. By “rinsing”, it is meant herein contacting the dishware cleaned with the process according to the present disclosure with substantial quantities of appropriate solvent, typically water. By “substantial quantities”, it is meant usually about 1 to about 20 L, or under running water.

The composition herein can be applied in its diluted form. Soiled dishware is contacted with an effective amount, typically from about 0.5 mL to about 20 mL (per about 25 dishes being treated), preferably from about 3 mL to about 10 mL, of the composition, preferably in liquid form, of the present disclosure diluted in water. The actual amount of composition used will be based on the judgment of the user and will typically depend upon factors such as the particular product formulation of the composition, including the concentration of active ingredients in the composition, the number of soiled dishes to be cleaned, the degree of soiling on the dishes, and the like. Generally, from about 0.01 mL to about 150 mL, preferably from about 3 mL to about 40 mL of a composition of the present disclosure is combined with from about 2,000 mL to about 20,000 mL, more typically from about 5,000 mL to about 15,000 mL of water in a sink. The soiled dishware is immersed in the sink containing the diluted compositions then obtained, before contacting the soiled surface of the dishware with a cloth, sponge, or similar cleaning implement. The cloth, sponge, or similar cleaning implement may be immersed in the composition and water mixture prior to being contacted with the dishware, and is typically contacted with the dishware for a period of time ranged from about 1 to about 10 seconds, although the actual time will vary with each application and user. The contacting of cloth, sponge, or similar cleaning implement to the dishware is accompanied by a concurrent scrubbing of the dishware.

Alternatively, the composition herein can be applied in its neat form to the dish to be treated. By “in its neat form”, it is meant herein that said composition is applied directly onto the surface to be treated, or onto a cleaning device or implement such as a brush, a sponge, a nonwoven material, or a woven material, without undergoing any significant dilution by the user (immediately) prior to application. “In its neat form”, also includes slight dilutions, for instance, arising from the presence of water on the cleaning device, or the addition of water by the consumer to remove the remaining quantities of the composition from a bottle. Therefore, the composition in its neat form includes mixtures having the composition and water at ratios ranging from 50:50 to 100:0, preferably 70:30 to 100:0, more preferably 80:20 to 100:0, even more preferably 90:10 to 100:0 depending on the user habits and the cleaning task.

### TEST METHODS

### Foaming

The foaming of a liquid detergent composition is assessed using a KRUSS DFA 100 Dynamic Foam Analyzer. The detergent composition is diluted to 20% by weight in water having a hardness of 2.67 mmol/l equivalent of CaCO3 at 22° C. 50 ml of the diluted solution is dosed using a syringe into a standard glass column (CY4501) fitted onto the Quick Fit Unit for agitation (SH4512), equipped with the standard agitator blade (SR4501). The initial solution height is recorded. The solution is then agitated for 5 seconds at 5000 RPM. 25 seconds after agitation has stopped, the total sample height and respective volume is recorded (foam and liquid solution). To calculate the height and respective volume of the foam, the initial solution volume is subtracted from the total volume measured.

### Grease Cleaning (Soil Release Index)

The grease cleaning performance test method is used to measure the relative grease removal efficacy of compositions across different dilution concentrations in water, at the specified hardness and temperature (0.5%, 1.0%, 3.0% concentrations of the liquid detergent composition in water of hardness 2.67 mmol CaCO₃ equivalence (15 dH) and 32° C.) versus a reference composition.

Homogenized lard (soil #44069 supplied by Warwick Equest Ltd. UK) is preheated to 60° C. in an oven for 2 hours, before being printed on to a polypropylene non-woven substrate (60 g/m2 SMS (spunbond-meltblown-spunbond) nonwoven produced by Avgol). The stain is then dried for 24 hours at 21° C. Wash solutions are prepared at the target composition concentrations, water hardness and temperature. The soiled substrates are placed individually in the wells of a 96 well microtiter plate and dosed with the wash solutions (950 μL wash volume per well) using a 96-channel pipetting head, for a contact time of 1 minute. The wash water is then removed using the 96-channel pipetting head. 4 rinse cycles were applied using the 96-channel pipetting head, each rinse cycle consisting of 800 μL ultra-pure water (Millipore®) at room temperature, applied for 2 minutes, before the rinse water is removed using the pipetting head. The substrates are then dried for 24 hours at 30° C.

Stain intensity is measured before and after the treatment through imaging using a Digi-Eye (supplied by Verivide UK, Z02791) and using imaging software to determine the average grease stain intensity before and after washing. The grease removal efficacy is subsequently expressed as a % SRI (Stain Removal Index—the higher the better). The % SRI results of 8 replicates per test condition are averaged and consequently plotted in a linear % SRI versus composition concentration plot. The sum of the % SRI at 0.5%, 1%, and 3% composition concentration is reported.

### Viscosity Measurement

The viscosity is measured using a controlled stress rheometer (such as an HAAKE MARS from Thermo Scientific, or equivalent), using a 60 mm 1° cone and a gap size of 52 microns at 20° C. After temperature equilibration for 2 minutes, the sample is sheared at a shear rate of 10 s⁻¹ for 30 seconds. The reported viscosity of the liquid hand dishwashing detergent compositions is defined as the average shear stress between 15 seconds and 30 seconds shearing divided by the applied shear rate of 10 s⁻¹ at 20° C.

### EXAMPLES

The following liquid hand dishwashing compositions were prepared by simple mixing. All the examples comprised the same level of surfactant and the same ratio of anionic surfactant to co-surfactant.

Both examples 1 and 2 are inventive examples of the present disclosure. Example 1 comprised anionic surfactant, an amine oxide amphoteric co-surfactant, and 1,2-octanediol. Example 2 comprised anionic surfactant, an amine oxide amphoteric co-surfactant, and 1,2-decanediol. Comparative example A comprised anionic surfactant, an amine oxide amphoteric co-surfactant, but did not comprise a mid-chain 1,2-alkanediol.

Comparative example D comprised anionic surfactant but comprised a betaine instead of an amine oxide surfactant as the co-surfactant, and did not comprise a mid-chain 1,2-alkanediol. Comparative example B was similar to example 1 but comprised a betaine instead of an amine oxide surfactant as the co-surfactant. Comparative example C was similar to example 2 but comprised a betaine instead of an amine oxide surfactant as the co-surfactant.

TABLE 1
Comparative and inventive liquid hand dishwashing detergent
compositions comprising amine oxide amphoteric surfactant
or betaine zwitterionic surfactant as co-surfactant.

| Wt % (100% active basis) | Ex 1 | Ex 2 | Ex A* | Ex B* | Ex C* | Ex D* |
|---|---|---|---|---|---|---|
| C12-C13 alkyl EO0.6 sulfate¹ | 12.15 | 12.15 | 12.15 | 12.15 | 12.15 | 12.15 |
| C12-C14 dimethyl amine oxide | 4.4 | 4.4 | 4.4 | — | — | — |
| Coco-amidopropyl betaine | — | — | — | 4.4 | 4.4 | 4.4 |
| 1,2-octanediol | 1.0 | — | — | 1.0 | — | — |
| 1,2-decanediol | — | 1.0 | — | — | 1.0 | — |
| Water and minors (perfume, dye, | bal. | bal. | bal. | bal. | bal. | bal. |
| preservatives, ethanol) | | | | | | |
| pH (10% solution in demi water) | 9 | 9 | 9 | 9 | 9 | 9 |
| Sum of % SRI at 0.5%, 1.0% and | 109 | 114 | 101 | 15 | 39 | 23 |
| 3% concentration | | | | | | |
| Foamability (ml) | 77 | 70.6 | 60.1 | 83.9 | 77.3 | 76.5 |

¹42.06% branching

It can be seen from the results of table 1, that liquid detergent compositions which comprise the amine oxide as the co-surfactant are typically less foaming than equivalent compositions comprising betaine instead. However, the mid-chain 1,2-alkanediols of use in the present disclosure have been found to be more effective at boosting foaming in compositions comprising the amine oxide co-surfactant than compositions comprising alternative co-surfactants such as betaines. This can be seen by comparing the foamability of examples 1 and 2 vs. that from comparative example A (28% and 17% foaming increase in comparison to amine oxide comprising compositions which do not comprise the mid-chain 1,2-alkanediol), and by comparing the foamability of comparative examples B and C vs. that from comparative example D, showing a lower percent foaming boost in the betaine-containing examples.

In addition, the compositions comprising the amine oxide as the co-surfactant have been found to provide more effective soil removal.

TABLE 2
Comparative and inventive liquid hand dishwashing detergent
compositions comprising amine oxide amphoteric surfactant
or betaine zwitterionic surfactant as co-surfactant,
and further comprising a nonionic surfactant.

| Wt % (100% active basis) | Ex 3 | Ex 4 | Ex E* | Ex F* |
|---|---|---|---|---|
| C12-C13 alkyl EO0.6 sulfate¹ | 6.61 | 6.61 | 6.61 | 6.61 |
| C12-C14 dimethyl amine oxide | 2.39 | 2.39 | — | — |
| Coco-amidopropyl betaine | — | — | 2.39 | 2.39 |
| C9-C11 EO8 ethox. nonionic | 7.55 | 7.55 | 7.55 | 7.55 |
| 1,2-octanediol | 1.0 | — | 1.0 | — |
| 1,2-decanediol | — | 1.0 | — | 1.0 |
| Water and minors (perfume, dye, | bal. | bal. | bal. | bal. |
| preservatives, ethanol) | | | | |
| pH (10% solution in demi water) | 9 | 9 | 9 | 9 |
| Foamability (ml) | 106.6 | 102.2 | 98.3 | 98.9 |

It can be seen from table 2, that the combination of amine oxide amphoteric co-surfacant and nonionic surfactant, in the context of the present disclosure, has been found to provide more effective foaming, in comparison to comparative compositions which comprise a betaine surfactant instead of the amine oxide co-surfactant. This is particularly surprising since, as can be seen from the foamability results of table 1, compositions of the present disclosure, which do not comprise nonionic surfactant, are less foaming than equivalent comparative compositions which comprise betaine co-surfactant and no nonionic surfactant.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any example disclosed or claimed herein or that it alone, or in any combination with any other reference or references, teaches, suggests or discloses any such example. Further, to the extent that any meaning or definition of a term in this document conflicts with any meaning or definition of the same term in a document incorporated by reference, the meaning or definition assigned to that term in this document shall govern.

While particular examples of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of the present disclosure.

What is claimed is:

1. A liquid hand dishwashing detergent composition comprising from about 5% to about 50% by weight of the composition of a surfactant system, wherein the surfactant system comprises anionic surfactant and amphoteric co-surfactant, wherein the amphoteric co-surfactant is selected from amine oxide surfactant, wherein the amine oxide surfactant has the formula: R1N(R2)(R3)O, wherein R1 is a C8-C18 alkyl, and the R2 and R3 moieties are selected from the group consisting of C1-C3 alkyl groups, C1-3 hydroxyalkyl groups, and mixtures thereof;
and wherein the composition further comprises from about 0.1% to about 10% of a mid-chain 1,2-alkanediol, wherein the mid-chain alkyl chain of the 1,2-alkanediol comprises from 6 to 14 carbon atoms.

2. The composition according to claim 1, wherein the composition comprises from about 0.25% to about 5.0% by weight of the liquid hand dishwashing detergent composition of the mid-chain 1,2-alkanediol.

3. The composition according to claim 2, wherein the composition comprises from about 0.5% to about 2.0% by weight of the liquid hand dishwashing detergent composition of the mid-chain 1,2-alkanediol.

4. The composition according to claim 1, wherein the alkyl chain of the mid-chain 1,2-alkanediol is a linear alkyl chain.

5. The composition according to claim 1, wherein the mid-chain 1,2-alkanediol is selected from the group consisting of: 1,2-hexanediol, 1,2-octanediol, 1,2-decanediol, 1,2-dodecanediol, 1,2-tetradecanediol, or mixtures thereof.

6. The composition according to claim 5, wherein the mid-chain 1,2-alkanediol is selected from the group consisting of: 1,2-octanediol, 1,2-decanediol, 1,2-dodecanediol, and mixtures thereof.

7. The composition according to claim 1, wherein at least about 50% by weight of the 1,2-alkanediols present in the composition are mid-chain 1,2-alkanediols.

8. The composition according to claim 7, wherein at least about 80% by weight of the 1,2-alkanediols present in the composition are mid-chain 1,2-alkanediols.

9. The composition according to claim 1, wherein the composition comprises divalent metal salts, selected from the group consisting of: magnesium and/or calcium salts of: chlorides, sulfates, carbonates, bicarbonates, linear alkyl benzene sulfonic acid, and mixtures thereof.

10. The composition according to claim 1, wherein the composition comprises from about 6.0% to about 40% by weight of the detergent composition of the surfactant system.

11. The composition according to claim 1, wherein the surfactant system comprises at least about 40% by weight of the surfactant system of the anionic surfactant.

12. The composition according to claim 1, wherein the anionic surfactant comprises at least about 70% by weight of the anionic surfactant of alkyl sulfated anionic surfactant, wherein the alkyl sulfated anionic surfactant has a number average alkyl chain length of from 8 to 18 carbon atoms.

13. The composition according to claim 12, wherein the alkyl sulfated anionic surfactant has a number average alkyl chain length of from 10 to 14 carbon atoms.

14. The composition according to claim 1, wherein the alkyl sulfate anionic surfactant has an average degree of alkoxylation of less than about 3.5.

15. The composition according to claim 1, wherein the anionic surfactant and the amphoteric co-surfactant are present in a weight ratio of from about 1:1 to about 8:1.

16. The composition according to claim 1, wherein the amine oxide amphoteric co-surfactant is selected from the group consisting of: alkyl dimethyl amine oxide, and mixtures thereof.

17. The composition according to claim 16, wherein the amine oxide amphoteric co-surfactant is C12-C16 dimethyl amine oxide.

18. The composition according to claim 1, wherein the surfactant system further comprises a nonionic surfactant, wherein the nonionic surfactant is selected from the group consisting of alkoxylated alcohol nonionic surfactants, alkyl polyglucoside nonionic surfactants, and mixtures thereof.

19. The composition according to claim 18, wherein the nonionic is an alkoxylated alcohol nonionic surfactant.

20. The composition according to claim 1, wherein the mid-chain 1,2-alkanediol and the surfactant system are present in a weight ratio of from about 1:60 to about 1:1.21. A method of cleaning dishware comprising the step of contacting the dishware with the composition according to claim 1.
